(19) United States
(12) Patent Application Publication
(10) Pub. No.: US 2006/0147028 A1
(43) Pub. Date: Jul. 6, 2006

(54) Multi-mode, multi-channel psychoacoustic processing for emergency communications

(75) Inventor: Jerry T. Hancock, Sausalito, CA (US)

Correspondence Address: GORDON & REES LLP, 101 WEST BROADWAY, SUITE 1600, SAN DIEGO, CA, 92101, US

(73) Assignee: Hanler Communications Corporation

(21) Appl. No.: 11/030,661

(22) Filed: Jan. 5, 2005

(51) Int. Cl. H04M 1/00; H04M 9/00

(52) U.S. Cl. 379/387.01

(57) ABSTRACT

An emergency radio communication system utilizes radios with headset, headphones, earphones and/or custom audio interfaces for a minimum of two audio channels. Each radio receives multiple channel/frequency communications and spatially locates the received communications at predetermined “ear” locations comprising left earphone, right earphone, and both earphones (right and left) according to the source of the received communications. In one specific example, a first fire department communications may be fed into the left earphone at a 100% level and a second fire department communications or air support communications may be fed into the right earphone at a 100% level. Control and command communications may be fed into both the left and right earphones at equal levels. Thus, in this example, the user spatially hears communications from the first fire department to the left, communications from the second fire department to the right, and communications from air support from the center.

### FIELD OF THE INVENTION

This invention relates generally to communication systems, and more specifically to radios and systems utilized by fire, police, air, military and other agencies for coordinated communications in the field. The system also has broad applicability to other communication systems where multiple groups communicate within their distinct group and/or with other disparate groups (“agencies” is the term used in the public service area). Throughout this document, the term, “5x ” refers to the invention in any physical packaging (mobile, console, portable).

### BACKGROUND OF THE INVENTION

Radio handsets of the prior art that are utilized by emergency personnel, e.g., police, fire, air support security agencies, may be set to a specific frequency and modulation mode to receive/send communications from a specific entity (agency), which typically is assigned its own communication frequency. Radio handsets may also have a channel for receiving all communications via, e.g., a broadband receiver, scanning or digital techniques. Current radios utilize a speaker and volume control, and generally do not utilize handsets, headphones, or earphones except in specialized applications.

Although stereo radio broadcasts may spatially locate sound on the right and left earphones, so that, for example, a string section of an orchestra is heard in the left earphone, the entire piece being broadcast is from a single source modulated on a single carrier frequency. In most

Although stereo radio broadcasts may spatially locate sound on the right and left earphones, so that, for example, a string section of an orchestra is heard in the left earphone, the entire piece being broadcast is from a single source modulated on a single carrier frequency. In most modulation modes, the phrase “single carrier frequency” actually encompasses a wide frequency bandwidth necessary to include the full audio or data signal. Also, right and left speakers may be adjusted to decrease or increase the dB level or phase of each audio channel. Thus, a transmission can be adjusted “spatially”. However, this type of adjustment applies for a single received transmission and typically is dependent on the source audio or data of the transmission.

### SUMMARY OF THE INVENTION

It is an object of the present invention to provide a new and improved communications system and method.

It is yet another object of the present invention to provide a process by which signals are presented to the users of the system using psychoacoustics.

It is yet another object of the present invention to provide a process by which a communications system or other communication devices separates differentiated audio information to present to a user the audio in an acoustic spatial location not unlike stereo commonly used for FM broadcast.

According to an exemplary embodiment of the present invention, an emergency communication system is provided, which utilizes radios with headsets, headphones, earphones and/or custom audio interfaces for a minimum of two audio channels. The communication system receives multiple channel/frequency communications and spatially locates the received communications at predetermined “ear locations” comprising a left earphone, a right earphone, and both earphones (right and left) according to the source of the received communications. In one specific example, a first fire department's communications may be fed into the left earphone at a 100% level and a second fire department communications may be fed into the right earphone at a 100% level. Control and command communications or air support communications may be fed into the left and right earphones at equal levels. Thus, in this example, the user spatially hears communications from the first fire department to the left, communications from the second fire department to the right, and communications from air support at the center (both earphones) thus differentiating received signals whether on one or multiple channels.

The system of the exemplary embodiment of the invention can also phase and/or vary the dB amplitude of the received signals to move a signal from direct left (or right) across a two dimensional soundfield to position a received channel/frequency at locations in addition to the direct left, right or center. Instead of hearing jumbled communication from multiple agencies talking over one another, the user is able to identify the source of the received communications by the relative position of the received audio in this two dimension stereo soundfield. Depending on the practicality of the headset, headphones, speakers, etc., to be positioned near the user to be affective, additional phasing can be applied utilizing a third audio channel with the result that the perceived soundfield moves from two dimensions to three. When the system is used as a console radio that uses external loudspeakers for audio presentation, six (or potentially more) audio output channels are available. In this case, the selectively received radio channel can be routed to any audio speaker, or to all speakers or a combination of speakers simultaneously.

The exemplary embodiment of the present invention may also include agencies that broadcast communications utilizing Independent Sideband (ISB) on the same RF channel. An ISB communications format allows users to transmit/receive different information on the upper and lower sidebands. The information on the upper and lower sidebands may be assigned a spatial location in the receiving radios. The ISB format as applied to this invention utilizes four sidebands, upper/upper, upper, lower and lower/lower. Two of the four are used for spatial positioning, one for data and a third for future three-dimensional spatial applications.

As the invention is described, the terms “channel” and “frequency” are used interchangeably. The system of the present invention does not rely on fixed channels for communications. The process by which the signals are presented to the users of the system using psychoacoustics is an improvement over prior art communication systems. The following features are utilized in the present invention:
a. Psychoacoustic Spatial Presentation—The presentation of channel specific information in a 1) user specified acoustic spatial location; 2) standard location through profiling; 3) dynamically using a data broadcast on the same or additional channel;
b. Transmitter Spatial selection—The ability of a user to select the transmitted spatial location using an Independent Sideband signal or other modulation methods/techniques. Assuming the transmitting and receiving user has a 5x enabled communication system, such a radio, the user of the transmitter can select the acoustic spatial position of the transmitted voice.

When the method is applied to a radio communications system(s), the use of a wideband transceiver (transmitter/receiver) enables a user of the system of the exemplary embodiment of the present invention to communicate in any appropriate modulation mode on any applicable frequency from approximately 100 khz to over 2.5 Ghz. The primary applications of the exemplary invention are as follows:
a. Adaptive Frequency Selection—Automatically switch to a lower frequency for better radio signal penetration to reach trapped workers or those whose signals are reduced due to building material. For example, the communication system can automatically switch from FM to SSB (single sideband) as signal conditions degrade. SSB requires approximately 1/10^{th} the power of FM. This allows the communication system to change to lower frequencies to better penetrate buildings and debris.
b. Multi-agency communications—Enable the user to speak to any other agency on that agency's assigned frequency and modulation method (AM, FM, Digital). For example, the 5x communication system can communicate with other agencies by utilizing multimode broadband radio techniques. The communication system has the ability to cover a wide frequency range from approximately 100 khz to 2.5 Ghz. The exemplary communication system can automatically change modulation and demodulation methods based on the channel through a stored profile in the communication system.
c. Automatic Modulation Selection—Automatically select the correct modulation method and channel set based on a profile stored and/or loaded into the communication system dynamically over a data sub-channel. In other words, the profile is dynamically updated as with the change or addition of more communication signals Automatic modulation selection is done using any of the following:
   1. stored channel profile
   2. automatically detected by Digital Signal Processing (DSP)
   3. keypad entry
The modulation methods can be by AM, FM SSB, ISB (5x communication system or other), or digital.
d. Low frequency data channel—The use of a low-frequency data channel for broadcast and emergency signals such as recall orders and distress signals. Once received, the radio would inform the user of the message using stored messages that could be downloaded or profiled by the communication system. The communication system uses a low frequency, low data rate, channel using ISB (or other) modulation(s) to communicate with other 5x radios. The data channel can be used to send/receive messages, emergency beacons, sensor data and profile update commands.

e. Process for profiling communication systems.—To maximize the flexibility of the communication system and to allow users to customize the various aspects of communications (channel, spatial position, etc.), the communication system stores information in a nonvolatile profile table. An example of a table that could be used with the communication system illustrated in. FIG. 1 is illustrated in Table 1. As can be seen from the table, there are 5 audio channels located on three different channels or frequencies. This table is utilized to determine a given frequency or audio input channel with an acoustical spatial position. The parameters or characteristics identified in the table below are listed by way of example only and additional parameters, such as PL tones, ID tones, digital tones, CTCSS, digital data and voice recognition, could be utilized.

TABLE 1

| | Modulation | | |
|---|---|---|---|
| Channel | Mode | Audio Channel | Description |
| 46.500 | FM | Left | Sausalito Fire |
| 125.000 | AM | Right | Fire Air Support |
| 39.000 | ISB | Left | User A |
| 39.000 | ISB | Right | User B |
| 39.000 | ISB | Center | Command & Control |

Each communications device is profiled depending on use. For example, team commanders will have different transmission and reception characteristics compared to other users. Using the flexibility of the psychoacoustic processing, one half of a team could be located in left audio channel and the other half in the right. Command and Control (dispatch) could be located in the center channel (both left and right).

For interagency communications or to communicate with other systems, additional information is added to the profile table. This information is used to associate a given frequency or audio input channel with an acoustical spatial position. In addition to spatial position (left, right, center, etc.), the table is also used to store applicable channels, modulation methods, and channel scanning priority. In order to communicate with multiple agencies on widely disparate frequencies, the exemplary communication system scans the applicable channels or audio inputs on a regular basis looking for signals. When a signal is present on more than one channel, the channel with the higher priority is selected or both channels can be presented (mixed) to independent soundfield locations if the applied system has the capability for simultaneous reception of two or more channels.

Multiple methods can be used to profile the communication system. These methods include:
(1) Using a predefined default configuration—A default configuration can be loaded into the radio and recalled at any time by the user or selected by the command and control center by use of the data channel.
(2) Dynamically loaded from a host PC through a charger base with a USB interface—While the radios are charging in their stands, they are connected to the console communication system attached to a personal computer using a USB interface. At the onset of an operation, a profile can be quickly downloaded into the communication system depending on needs. The download will take less than a second and be initiated by a person in control, such as a dispatcher.
(3) Dynamically reconfiguring using a low speed data channel—As the communications requirements change during an emergency, the communications systems profile table can be updated by downloading the new channels, priorities, modulation methods and spatial representations over the data channel.

Typical users of the present invention will be public services or military services personnel such as Fire Departments, HAZMAT, FEMA and Police. The communication system also has broad commercial application across all users of two-way communications including FRS (family radio service) GMRS, cellular and land line telephone systems. The channel scanning with spatial locations determined by channel can also be applied to any RF scanning devices (e.g. commercial police, fire scanners).

The communication system utilized with the present invention may be pre-set to assign specific channels or audio inputs to specific spatial locations at the receiver. The communications system of the exemplary embodiment also allows the user to define the spatial locations using profiles stored in the communication system. In addition, a command and control center may transmit a profile change to communication systems over the third data channel.

Secondary to the spatial location application, the communication system of the exemplary embodiment of the present invention includes additional inventive features. Specifically, the communications system has the ability to be profiled with spatial locations on an emergency or situation type and dynamically updated as additional entities, or agencies, enter or leave the system. The communications system can send/receive low speed test messages including emergency alerts. The communications system also can interface (portable version) to external sensor such as temperature, oxygen, global positioning system (GPS), etc. for monitoring by the command/control center. Further, the communications system can dynamically change the assigned frequency for communications higher or lower to accommodate changing propagation conditions. The command/control system installation of the exemplary embodiment monitors and tracks the location of the users via collected GPS data, and graphically displays the information on an attached computer terminal.

The foregoing, together with other features and advantages of the present invention, will become more apparent when referring to the specification, claims and accompanying drawings.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 is an illustration of communication from various sources to the headphones or earphones of a user according to an exemplary embodiment of the present invention;

FIG. 2 is a schematic block diagram of the exemplary receiver communication system frequency hardware and control of the communication system;

FIG. 3 is a schematic block diagram of the digital signal processor (DSP) and related hardware of the exemplary system;

FIG. 4 is an outline of the DSP software architecture in the receive mode;

FIG. 5 is a schematic block diagram of the transmitter RF hardware and control;

FIG. 6 is an outline of the DSP software architecture in the transmit mode; and

FIG. 7 is a block diagram of the control software architecture.

### DETAILED DESCRIPTION

The following detailed description utilizes a number of acronyms which are generally well known in the art. While definitions are typically provided with the first instance of each acronym, for convenience, Table 1 below provides a list of the acronyms and abbreviations and their respective definitions.

TABLE 1

| ACRONYM | DEFINITION |
|---|---|
| AM | Amplitude Modulation |
| FM | Frequency Modulation |
| GPS | Global Positioning System |
| ISB | Independent Sideband |
| RF | Radio Frequency |
| DSP | Digital Signal Processor |
| CP | Control Processor |

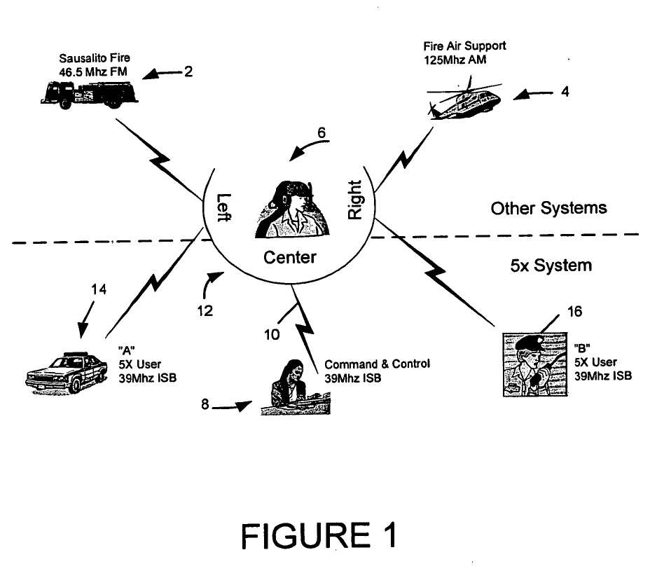

FIG. 1 is an illustration of communication from various sources to headphones or earphones of a user according to an exemplary embodiment of the present invention. To communicate with the user, the communications system utilizes a multi-mode, multi-channel, psychoacoustic processing when multiple agencies respond to a disaster. A dashed line divides the systems in FIG. 1. Above the dashed line are systems that utilize traditional non-5x communication systems, such as a fire engine 2 or a helicopter 4. Below the dashed line are systems that are part of a 5x communication system of the exemplary embodiment of the present invention. The users below the dashed line (8, 14, 16) are “5x” system users, wherein the “5x” terminology used herein is an arbitrary nomenclature to identify an independent sideband (ISB) based system. A typical 5x user 6 is illustrated in the center of FIG. 1. The communication system of the present invention is implemented as part of a radio system in the exemplary embodiment. Those skilled in the art will recognize that the principles and teachings described herein may be applied to a variety of applications or industries such as a cell phone, a telephone, an intercom, an external audio line and a computer.

Referring to FIG. 1, at a high level, the communication system consists of one or more dispatch or command and control consoles 8 communicating with many mobile or portable communication systems (such as walkie-talkies). In this illustration, the 5x communication systems are diagrammed below the central dotted line. The 5x communication system can also communicate with other communication systems as diagrammed above the dotted line.

Most two-way communication systems today use a single audio channel for voice though some systems use a signaling tone to identify the transmitter of the calling user. The 5x communication system of an exemplary embodiment the present invention isolates users pyschoacoustically in a stereo soundfield opposed (or in addition) to the signaling tone. As illustrated in FIG. 1, command and control signals 10 are routed to the center acoustic spatial position 12, mobile communications among team members are routed to the left position, and a second police unit 16 is routed to the right. Typically, emergency transmissions would be routed to both ears. By phasing two audio channels, the signals can be rotated to any position in the stereo soundfield though in practice, left, right, and center are more easily discernable.

As the 5x communication system of an exemplary embodiment of the present invention utilizes software defined radio technology, any radio could be programmed to be compatible with all radio systems currently in use. Also shown in FIG. 1 is the communication system's ability to switch modulation methods depending on the channel and modulation needed to maintain compatibility with older technology. In this illustration, FM is being used for communications with the fire truck 2, AM is in use with the assisting helicopter 4, and Independent Sideband, ISB, (also 5x mode) is being used for the police car 14 and portable police unit 16. Combining this feature with the psychoacoustical processing will enable the communication system to easily present independent channels and/or users on the same channel, in either or both ears.

As discussed previously, the channels, modulation method per channel, spatial location and other factors are held in a profile table. The profile table is dynamically updated as with the change or addition of more communication signals. Table 1 below illustrates an example of a profile table utilized with an exemplary embodiment of the present invention. The parameters or characteristics identified in the table below are listed by way of example only and additional parameters, such as PL tones, ID tones, digital tones, CTCSS, digital data and voice recognition, could be utilized.

TABLE 1

| | Modulation | | |
|---|---|---|---|
| Channel | Mode | Audio Channel | Description |
| 46.500 | FM | Left | Sausalito Fire |
| 125.000 | AM | Right | Fire Air Support |
| 39.000 | ISB | Left | User A |
| 39.000 | ISB | Right | User B |
| 39.000 | ISB | Center | Command & Control |

In the example illustrated in FIG. 1, Sausalito Fire and Air Support are engaged in an emergency. The communication systems above the line are on disparate frequencies and use both amplitude modulation (AM) and frequency modulation (FM) methods. The 5x communication system users are employing Intermediate Side Band (ISB) on the same RF channel. The 5x communication system scans the responding agency channels looking for an active signal that breaks a predetermined level using a traditional squelch circuit implemented in software. The scanning is prioritized by the communication system controller using a profile that consists of a table of frequencies, modulation methods, audio spatial locations, scanning priority and other parameters. The scanning priority scheme is implemented using commonly utilized methods in the industry. For example, the priority scheme could be as simple as replicating the higher priority channels or signals throughout the profile table so that higher priority signals appear more frequently. This will have the consequence of those channels being scanned at a higher relative rate compared to lower priority signls. The communication system can be pre-configured or dynamically re-configured using the data channel (not shown) during an event. The user hears the Sausalito Fire department 2 in his left ear, Air support 4 in his right ear and command and control 8 in both ears. During scanning, the on-board controller of the communication system selects the specific channel and retrieves the proper modulation method and spatial location from the profile table.

As the communication system continues around the scanning loop, when it selects 5x user “A” 14 or “B” 16, both ISB channels of the same channel are processed by the receiving radio enabling the transmitting station to select the spatial location for the receiver This is functionally equivalent to listening to a stereo broadcast with one or more users in one ear and a different user(s) in the opposite ear.

Though the software defined radio architecture will allow the communication system to operate in any modulation mode, the use of the ISB has many advantages over traditional FM or newer digital modes. Using ISB, the user can select the audio channel (on the same RF frequency channel) to broadcast. In one example, buttons may be provided on the left and right side of the microphone, or other convenient location. Pressing the left button on the microphone will signal the communication system to transmit the signal to the other user's left ear. Likewise pressing the right button will transmit to the user's right ear. By pressing both, both audio channels will be broadcast. Unlike FM and digital modulation modes, ISB and SSB signals can be heard by a third party when two other users press the talk button at once. ISB also has an advantage over FM in terms of required signal power. FM typically requires over ten times the signal strength to meet minimum discernable signal requirements.

There is a great deal of flexibility when using ISB since either the transmitter or receiver can select the audio spatial location depending on the profile or dynamically using the data channel. The transmitting communication system, for example, the command and control center, can transmit a profile change prior to activating the transmitter microphone. This allows the user to change audio spatial locations with each transmission. Since each communication system has a stored profile table, different users can hear, for instance, another fire department, on either the left or right audio channel. Furthermore, the output acoustical spatial location is selected from the group consisting of left, right, center, left-center, right-center, above, below, behind and any intermediate spatial location in a three dimensional sound field. Additionally, the output acoustical spatial location is simulated by associating a selected input communications signal with one or many loudspeakers, headphones or audio transducers spatially located to present a distinct sound location source.

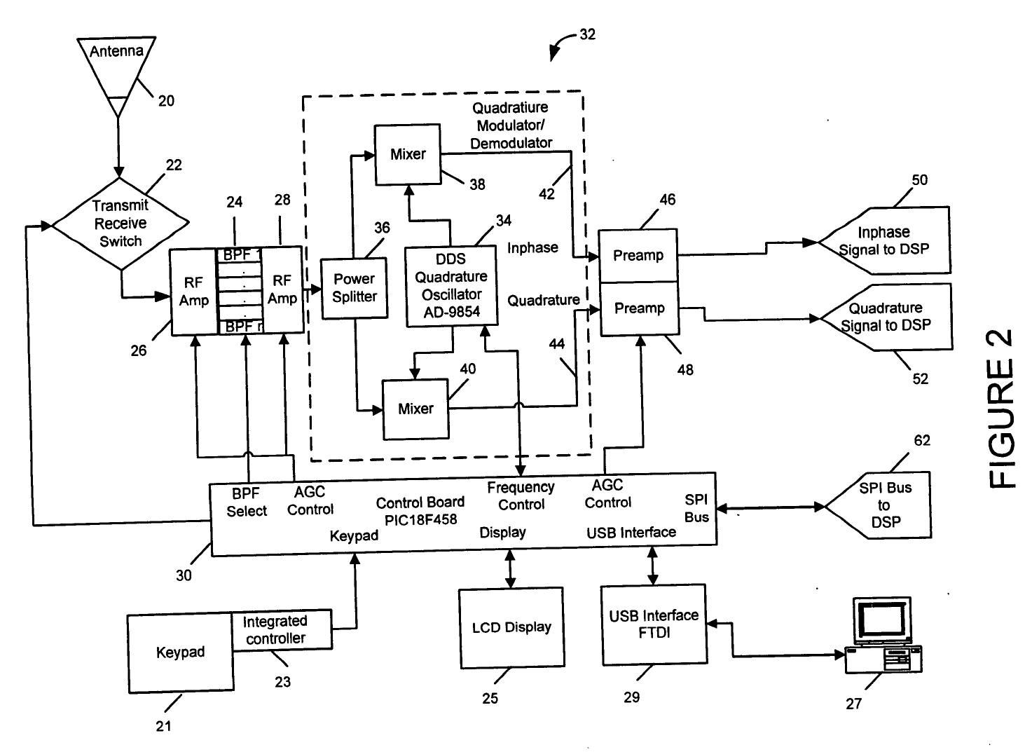

FIGS. 2-7 illustrate a functional overview of a communication system, such as a radio, including functional hardware and software elements, in an exemplary embodiment of the present invention. The functional overview of the system can be used with regard to three models: portable, mobile and console models of the radio system. The three models are functionally identical with the exception of power output being increasingly higher from portable to console. The mobile and console versions also have more digital signal processing (DSP) power.

In general, the three models (portable, mobile, console) share the same architecture. The portable is the smallest and lightest unit. The mobile radio is larger due to the higher power RF and audio output. The levels of signal processing increase from portable (300/600 mflops) through mobile (600/1200 mflops) to console (1800/3600 mflops). The console radio is completely computer controlled utilizing the USB interface. In the event of a computer failure, a backup computer can take over or the radio can be operated using a keypad. All three models include a keypad and controller, which includes switches and other hardware for external control of the radio. All three models have a keypad though the console would be primarily computer controlled. The integrated controller on the keypad handles matrix key decoding. The models also each have an LCD display which has a standard controller and is initialized and driven by a controller processor. Current channel, modulation modes, priority and other status information are displayed. The three models also have a USB interface. A FTDI USB (or other manufacturer) chip controls the USB interface to an external personal computer. The USB interface is used to profile and update all radio models. In addition, the console model is controlled through this interface.

Turning to FIG. 2, the hardware used when the communication device, such as a radio, is in receive mode is illustrated. A signal is received from an antenna 20 and is routed through transmit/receive logic 22 to a set of band pass filters 24 bracketed by a pair of RF signal amplifiers 26, 28. The RF amplifiers 26, 28 are gain-controlled by a control board 30. This is necessary to amplify or limit the RF signal to maintain a level of optimal for the Digital Signal Processor (DSP).

After leaving the second RF amplifier 28, the signal is routed to a quadrature modulator/demodulator 32 that uses a local oscillator complex signal (sine/cosine) injection from a Direct Digital Synthesis (DDS) 34 signal generator. The quadrature modulator/demodulator 32 may be implemented using a discrete power splitter 36, mixers 38, 40 and other hardware. Once the signal is mixed from RF to the 12 khz IF frequency in the quadrature modulator/demodulator 32, the cosine and sine mixed signals, now termed the in-phase 42 and quadrature 44 signals, are routed to the DSP through a pair of audio amplifiers 46, 48.

When the system is in the receive mode, the control processor provides the following to the communications system:
1. Initialization of external peripheral (LCD, keyboard control, USB, SPI)
2. Transmit/receive switching
3. Band Pass Filter selection by channel
4. AGC control of analog RF stages
5. Keypad interpretation
6. Channel Scanning
7. Demodulation Selection
8. Frequency control of DDS
9. LCD display updates
10. USB processing from PC (profiles, software updates, etc.)
11. Squelch processing when in Scan mode
   The control processor communicates with the DSP through a three-wire bus 62 using SPI protocol. Typical transfers would include modulation mode selections while in channel scanning mode, squelch, AGC gain changes from the DSP, etc. The communication systems are charged in their stands and are attached to a device, such as a console, through a personal computer 27 using a USB interface 29. As discussed previously, in the event of a computer failure, a backup computer can take over or the communication system, such as a radio and can be operated using a keypad 21. There is an integrated controller 23 on the keypad 21 that handles matrix key decoding. Furthermore, each model described above has an LCD display 25 for displaying pertinent control information (selected channel, modulation mode, etc.) and user interaction/responses.

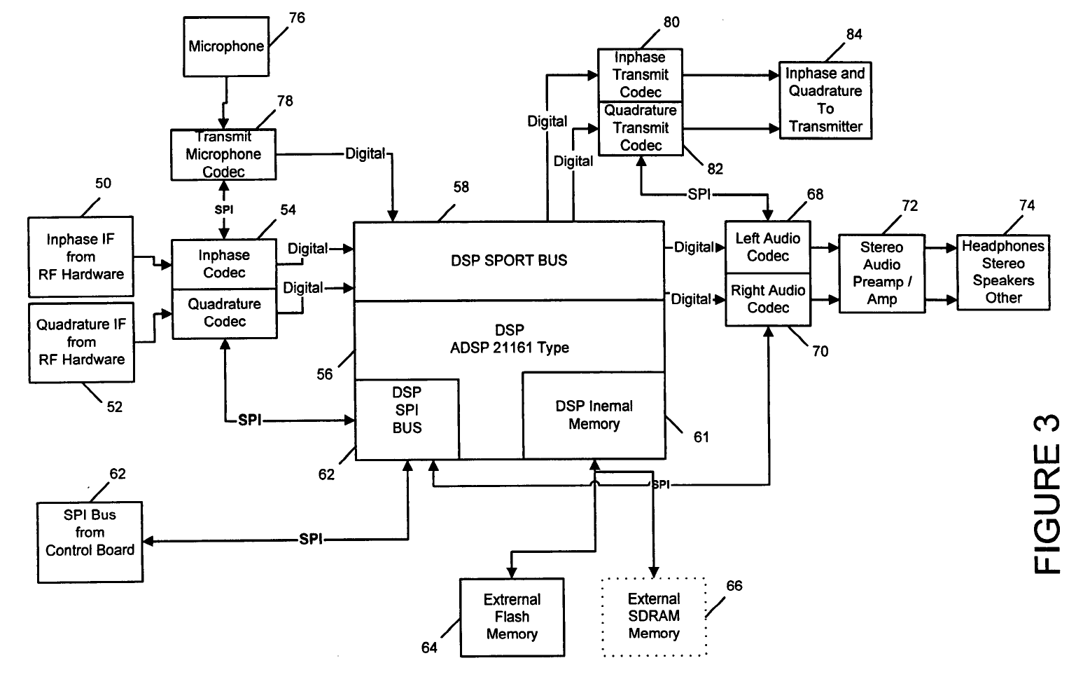

FIG. 3 illustrates a schematic block diagram of the digital signal processor (DSP) and related hardware of a system that can be utilized with an exemplary embodiment of the present invention. This hardware can be used to both transmit and receive signals. It handles the modulation in transmit mode and demodulation in receive mode, along with squelch detection and automatic gain control. After the signal leaves the RF hardware in FIG. 1 through preamplifiers 46, 48, the in-phase 50 and quadrature 52 signals are routed to a multi-channel CODEC 54. The CODEC 54 converts the signals from analog to digital for input to the DSP 56. Though diagrammed as separate units, the many CODECs on the diagram are actually one unit. Once converted to digital, the in-phase and quadrature signals enter the DSP 56 through the SPORT bus 58 that is proprietary to the DSP 56 employed, such as an Analog Devices ADSP-21161. The DSP 56 communicates with the control processor 30 (shown in FIG. 1) through the SPI bus 62. The SPI bus 62 is also used to configure and control the CODEC(s) employed. The DSP 56 loads and maintains status in an external Flash memory 64. The DSP 56 also contains DSP Internal Memory 61 for containing the executing program and other transient data and structures. An external SDRAM memory 66 is also used on the console version of the 5x communication system for expansion of programming routines and data.

Once processed, the data exits the DSP 56 again through the SPORT bus 58 and is converted to analog in the left 68 and right 70 audio CODEC(s). The signal is then amplified 72 and routed to an external connector 74 for headphones or other transducers in the portable model; stereo speakers in the mobile and console models; and external recording hardware in the console. In transmit mode, the microphone audio 76 is converted from analog to digital in the respective CODEC 78, processed again through the DSP SPORT bus 58, and converted to in-phase 80 and quadrature 82 signals fro the transmit mode hardware 84.

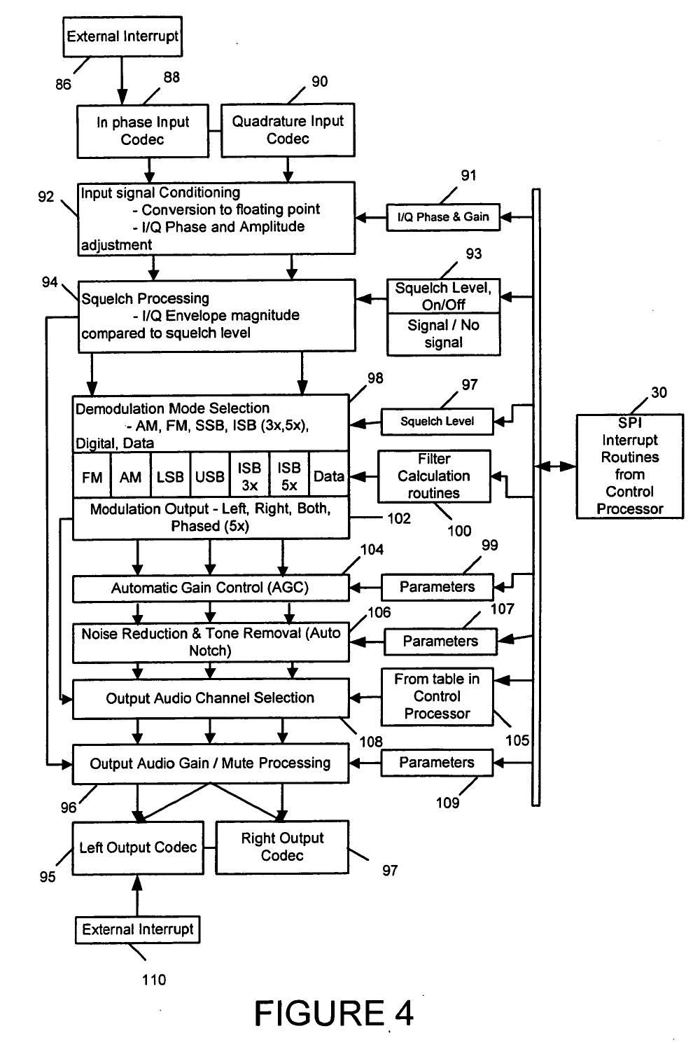

FIG. 4 illustrates an outline of the DSP software architecture in the receive mode of a system that can be utilized with an exemplary embodiment of the present invention. After boot initialization routines, the software enters a loop waiting for synchronized input/output interrupts 86 from the respective CODEC(s). Once an interrupt 86 occurs, the in-phase 88 and quadrature 90 signal data is made available for processing. The signals are then converted from fixed to floating point and gain adjusted 91 to account for mismatches in phase or amplitude in the RF hardware 92. The phase and amplitude adjustments are made by the control processor 30 through the SPI interrupt routines and are handled dynamically by the software. If the squelch is set on 93, the envelope amplitude of the in-phase (I) and quadrature (Q) (I/Q as a pair) signals are compared 94 to a dynamically set level from the control processor 30. Assuming the signal exceeds the squelch level, the audio output is unmuted 96. A command is also sent via the SPI bus to notify the control processor 30 to interrupt channel scanning if active. This enables the communication system to lock onto one of many channels.

The I/Q signals 97 are then routed to the correct demodulation routine 98 by commands from the control processor 30. The control processor 30 can also use issue commands to change the filter calculation routines 100 for each demodulation mode. The demodulation output 102 consists of either one or two audio channels depending on the mode and/or control processor commands. For instance, AM and FM (non-5x modes) demodulation routines output a center channel (mono) signal. In 5x mode, the demodulated Independent Sideband Signal sets the output channel selection unless the control processor overrides it.

After leaving the selected modulation routine 102, the automatic gain control processing 104 is performed if enabled. Certain AGC routines are always performed depending on the RF input signal strength. Depending on the modulation mode, noise reduction or tone removal 106 can be employed. This is accomplished in software using an adaptive filter based on a variant of the LMS algorithm. At this point the signal is demodulated to the selected audio output channel (left, right or center) 108. The control processor 30 makes the selection based on a stored profile table 105. The audio data is then processed for output gain or muted and during the next CODEC interrupt, sent to the CODEC(s) 95, 97 over the SPORT bus. The software then re-enters a routine waiting for the next input CODEC interrupt 110. Parameters, identified as 99, 107 and 109, are used by the respective routines to set default and dynamic levels for AGC 99, noise reduction 107 and Output Audio Gain 109.

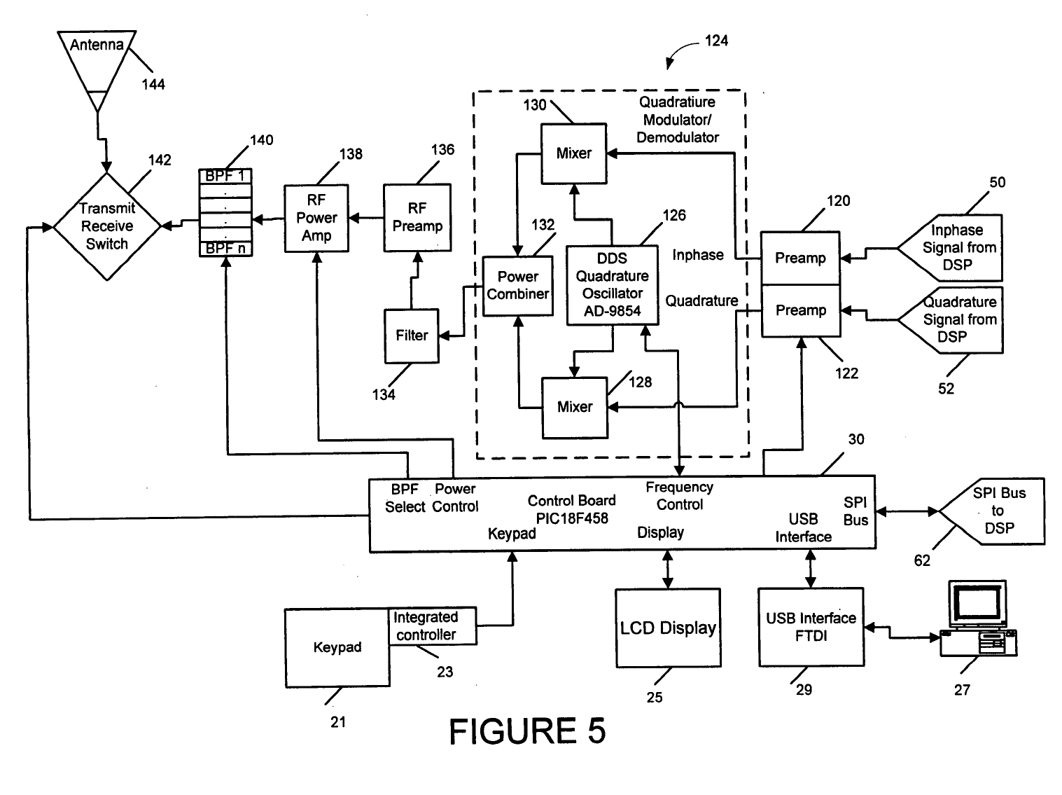

FIG. 5 is a schematic block diagram of the transmitter RF hardware and control of a communication system that can be utilized with an exemplary embodiment of the present invention. The in-phase (I) 50 and Quadrature (Q) 52 signals from the DSP enter on the right and are pre-amplified 120, 122 to a level required by the quadrature modulator 124. The modulation mode and spatial position of the signal have been determined by the DSP at this point. The control processor sets the final output frequency of the DDS 126 and this signal is mixed 128, 130 with the l/Q channels. The signals are combined 132 and routed to a broadband filter 134, amplified 136, 138, filtered 140, and sent through the transmit/receive switching 142 to the antenna 144. In addition to the frequency control, the control processor 30 also monitors and controls the power output. In the console and mobile models, the monitoring would include feedback on antenna and feed line conditions (forward and reflected power).

As with FIG. 2, the communication systems are charged in their stands and are attached to a device, such as a console, through a personal computer 27 using a USB interface 29. As discussed previously, in the event of a computer failure, a backup computer can take over or the communication system, such as a radio can be operated using a keypad 21. There is an integrated controller 23 on the keypad 21 that handles matrix key decoding. Furthermore, each model described above has an LCD display 25 for displaying pertinent control information (selected channel, modulation mode, etc) and user interaction/responses.

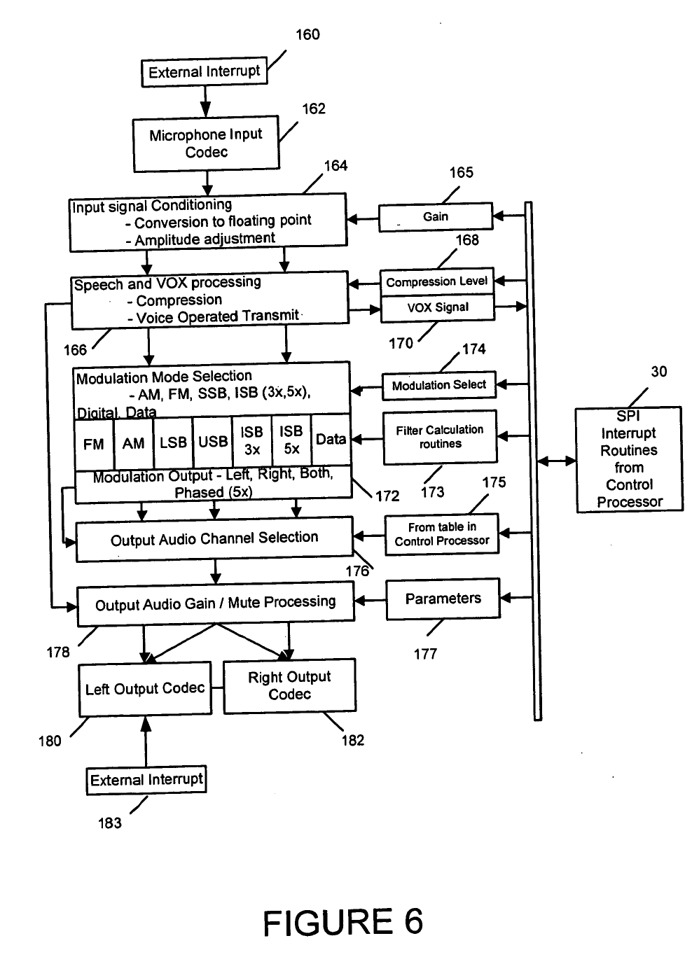

FIG. 6 is an outline of the DSP software architecture in the transmit mode that can be utilized with an exemplary embodiment of the present invention. In transmit mode an interrupt 160 signals the CODEC that audio should be sampled from the external microphone 162, amplifies the audio and converts the signal to digital for DSP processing. The signal is converted to floating point and amplitude adjusted (using gain parameters 165) for optimal processing 164. After conditioning, the signal is processed by a speech compression routine to raise the average signal strength. If Voice Operated Transmit (VOX) is being employed, the processed signal is compared to the VOX set point 170 and if it exceeds a level set 168 by the control processor 30, the radio is switched to transmit mode 166. If Push To Talk (PTT) is being employed, the radio is switched to transmit immediately upon pushing one of many PTT buttons on the keypad or radio case.

The multiple PTT buttons are used in conjunction with logic in the control processor (as specified in the profile) to indicate the output audio channel (when received by a compatible receiver) to enable the user transmitting to specify the receiver's output audio spatial location. If VOX is being employed, the default audio output channel (of the receiver) is specified in the profile. To summarize, the transmitting user can select the audio channel output of the receiver (left, right, center, etc) by any of the following means:
1) by default as profiled in the radio
2) by profiled location using the last channel received (receive channel “A” last, transmit next on channel “A”
3) by a pressing combination of buttons on the radio case (i.e. Left for left output, right for right output, both for center output)
4) by data received on the last or prior receptions

The audio is then sent to the modulation selection routines 172. Depending on the control processor profile table 175, the correct modulation routine is called to generate the output signal. The control processor also selects (in conjunction with the modulation mode) 174 the correct audio output channel when in 5x mode 176. After a signal is conditioned, modulated and the spatial location determined, the signal is then gain adjusted 178 and passed to the in-phase (I) 180 and quadrature (Q) 182 output CODECs and externally routed to the transmit hardware. Parameters 177 are used to set the output gain to optimize the signal for transmission.

As part of the modulation process to generate the I/Q signals, filters are required that contain both bandwidth limiting characteristics (speech only) and Hilbert transform functions (to phase shift the signal). These filter structures are stored and/or calculated by filter calculation routines 173.

External interrupt 183 is linked to the input external interrupt 160 to signal the output CODEC to convert the signal from Digital to Analog for presentation to transmitter hardware 50 and 52 (shown in FIGS. 2 and 5).

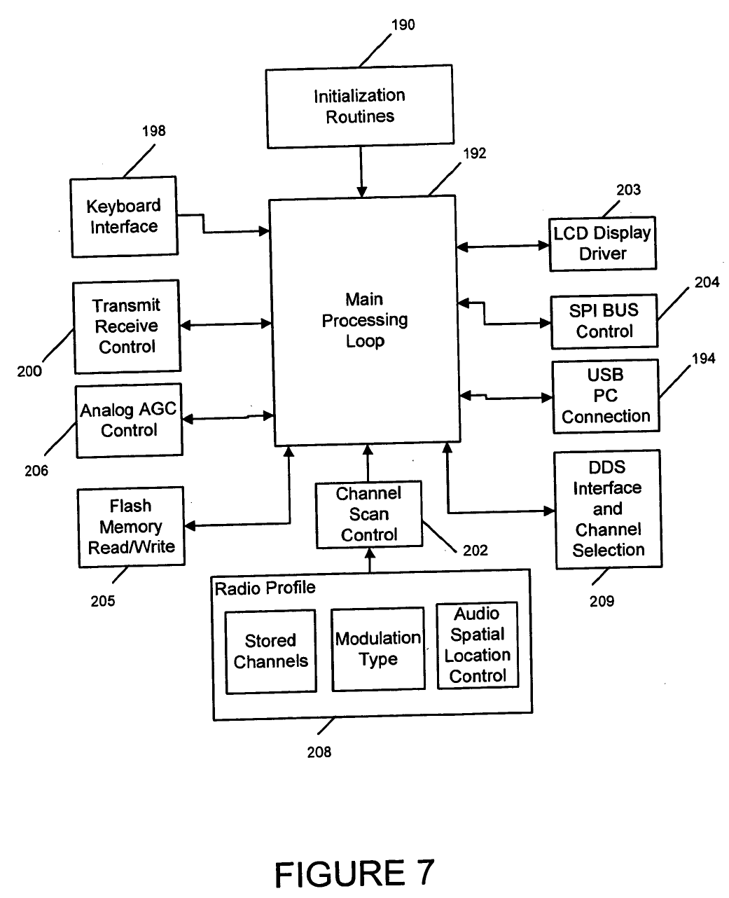

FIG. 7 is a block diagram of the control software architecture that can be utilized with an exemplary embodiment of the present invention. After initialization 190, the control processor software runs an interrupt driven processor loop 192. Routines are called as needed to handle (1) USB commands from a personal computer 194, (2) LCD display drivers 203 to display information, (3) squelch, AGC VOX and other interrupt signals from the DSP, (4) flash memory read/write 205 for loading and maintaining the status of DSP (5) keyboard input 198 including transmit/receive switching 200, band pass filter and other hardware control, (6) channel scanning 202 with interrupts and parameters passed to the DSP; (7) SPI bus control 204 for pass through from PC to DSP, and (8) analog AGC control 206 or receive hardware (pass through commands from DSP). A communication system or radio profile 208 comprising channels, modulation type and audio spatial location control and other parameters which is used to associate a given frequency or audio input channel with an acoustical spatial position.

The DDS (Direct Digital Synthesis) Quadrature Oscillator used in both the transmitter FIG. 5, 126 and FIG. 2, 34 are controlled or updated by the control processor as indicated by 209 under either channel scan control 202 or when directly entered by the keyboard interface 198.

Although an exemplary embodiment of the invention has been described above by way of example only, it will be understood by those skilled in the field that modifications may be made to the disclosed embodiment without departing from the scope of the invention, which is defined by the appended claims.

1. A method for enhancing a user's ability to discern the source and/or priority of communications, the method comprising the steps of:
scanning input communication signals for an active signal;
determining if other characteristics are available on the received signal to further define the signal;
programming a communication device with a profile;
utilizing the profile to prioritize the communication signals; and
associating a given input communication signal with an acoustical spatial location or loud speaker.

2. The method of claim 1, wherein the profile comprises the channels, modulation method per channel, priority, squelch level, volume and acoustical spatial location.

3. The method of claim 1, wherein the communication device is programmed with an on-board controller of the communication device; and
wherein the on-board controller selects the specific channel and retrieves the proper modulation method and spatial location and the other characteristics from the profile table.

4. The method of claim 1, wherein the user can change output audio spatial locations with each transmission.

5. The method of claim 1, wherein other characteristics are selected from the group comprising PL tones, ID tones, digital tones, CTCSS, digital data and voice recognition.

6. The method of claim 1, wherein the communication device is selected from the group consisting of a cell phone, a telephone, an intercom, an external audio line, a computer, and a radio.

7. The method of claim 1, wherein the communication device enables a transmitting station to select the spatial location for the receiver.

8. The method of claim 1, further comprising the step of routing the communication signals to at least one output audio channel.

9. The method of claim 1, wherein the output acoustical spatial location is selected from the group consisting of left, right, center, left-center, right-center, above, below, behind and any intermediate spatial location in a three dimensional sound field.

10. The method of claim 1, wherein the output acoustical spatial location is simulated by associating a selected input communications signal with al least one loudspeaker, headphone or audio transducer spatially located to present a distinct sound location source.

11. The method of claim 1, wherein the profile is dynamically updated as with the change or addition of more communication signals.

12. A method of selecting the acoustic spatial location of a transmitted signal, the method comprising the steps of:
sampling the input audio signal upon detection on an interrupt;
amplifying the signal and converting the signal to digital for DSP processing;
processing the signal by a speech compression routine to raise the average signal strength;
comparing the signal to a VOX set point and if the signal exceeds a level set by a control processor switching a communication device to transmit mode, the VOX is enabled;
switching a communications device to transmit mode using at least one button if the VOX is disabled; and
determining the output acoustic spatial location of a receiver of the signal utilizing a table located in the communication device.

13. The method of claim 12, further comprising the step of transmitting the signal on an appropriate channel.

14. The method of claim 12, further comprising the step of conditioning the signal with appropriate characteristics.

15. The method of claim 12, further comprising the step of sending data on the same channel or sub-channel so the receiver can use parameters stored in the table to differentiate the transmitted signal so as properly to select the output acoustic spatial location of the receiver.
